(19) United States
(12) Patent Application Publication
(10) Pub. No.: US 2026/0172124 A1
(43) Pub. Date: Jun. 18, 2026

(54) SIGNALING TO RESOLVE CONFLICTS ASSOCIATED WITH ANTENNA SELF-CALIBRATION AT A RADIO UNIT

(71) Applicant: QUALCOMM Incorporated, San Diego, CA (US)

(72) Inventors: Soumen MITRA, Hyderabad (IN); Aman Kumar SINGH, Hyderabad (IN); Guruvardhan ROUTHU, Hyderabad (IN); Loksiva PARUCHURI, Hyderabad (IN); Tushar SINGH, Hyderabad (IN)

(21) Appl. No.: 19/128,895

(22) PCT Filed: Aug. 18, 2023
(86) PCT No.: PCT/US2023/072508

§ 371 Date: May 9, 2025

(30) Foreign Application Priority Data
Dec. 16, 2022 (IN) 202241073188

(51) Int. Cl. H04B 17/12; H04L 5/00; H04W 72/0446; H04W 72/23; H04W 88/06

(52) U.S. Cl. CPC H04B 17/12; H04L 5/0048; H04W 72/0446; H04W 72/23; H04W 88/06

(57) ABSTRACT

A radio unit (RU) of a base station may perform an antenna calibration using resource elements (e.g., time and frequency resources). When a distributed unit (DU) becomes busy, upper protocol layers (e.g., layer 2 implemented at the DU) may schedule resources for data traffic on these resource elements, resulting in data loss. In addition, the RU may experience delays when waiting for a timer to expire to begin performing an antenna self-calibration operation. The apparatus described herein receives, from a DU, a first notification message indicating a busy status of the DU. The apparatus transmits a second notification message to the second protocol layer at the DU in response to the first notification message, the second notification message indicating that an antenna self-calibration operation is to be performed at the apparatus.

### CROSS-REFERENCE TO RELATED APPLICATION

The present Application claims priority to and the benefit of Indian Patent Application, Serial No. 202241073188, filed in the Indian Patent Office on Dec. 16, 2022, the entire content of which is incorporated herein as if fully set forth below in its entirety and for all applicable purposes.

### BACKGROUND

### Technical Field

The present disclosure relates generally to communication systems, and more particularly, to signaling to resolve conflicts associated with antenna self-calibration at a radio unit.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A radio frequency (RF) antenna (also herein referred to as an antenna) is typically calibrated to verify the performance and the measurement of the antenna's properties. In some examples, calibration of an RF antenna may be performed at an RF Front-End (RFFE) of a wireless communication device, such as at a radio unit (RU) in an open radio access network (O-RAN) system.

An RU may perform an antenna calibration using resource elements (e.g., time and frequency resources). However, the resource elements used for antenna calibration may not be used to carry traffic (e.g., data traffic). In some scenarios, upper protocol layers (e.g., layer 2 implemented at a distributed unit (DU) in an O-RAN system) may schedule resources for data traffic on the resource elements used for the antenna calibration. This may result in scheduling conflicts and data loss. In addition, the RU may experience delays when waiting for a timer (e.g., a calibration timer for controlling the start of an antenna self-calibration operation) to expire to begin performing an antenna self-calibration operation. The aspects described herein overcome these issues.

In an aspect of the disclosure, a method, a computer-readable medium, and an apparatus are provided. The apparatus may be an RU. The apparatus receives, from a distributed unit of a base station, a first notification message indicating a busy status of the distributed unit, wherein the distributed unit implements a first protocol layer and at least a second protocol layer, wherein the second protocol layer is higher than the first protocol layer. The apparatus transmits a second notification message to the second protocol layer in response to the first notification message, the second notification message indicating that an antenna self-calibration operation is to be performed at the apparatus.

In an aspect of the disclosure, a method, a computer-readable medium, and an apparatus are provided. The apparatus may be an RU. The apparatus receives a first notification message indicating a busy status of a distributed unit of a base station. The apparatus transmits, to a network device configured to schedule resources for traffic, a second notification message indicating that an antenna self-calibration operation is to be performed at the apparatus in response to the first notification message.

In an aspect of the disclosure, a method, a computer-readable medium, and an apparatus are provided. The apparatus may be a DU. The apparatus transmits a message that allows a radio unit of a base station to perform an antenna self-calibration operation. The apparatus transmits, to the radio unit, a notification message indicating a busy status of the apparatus to at least reduce a delay associated with the antenna self-calibration operation at the radio unit.

In an aspect of the disclosure, a method, a computer-readable medium, and an apparatus are provided. The apparatus may be a network device. The apparatus receives, from a radio unit of a base station, a notification message indicating to at least one upper layer implemented at the apparatus that an antenna self-calibration operation is to be performed at the radio unit, the notification message indicating one or more resources associated with the antenna self-calibration operation. The apparatus schedules resources for at least one of an uplink transmission or a downlink transmission based on the one or more resources associated with the antenna self-calibration operation.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 shows a diagram illustrating an example disaggregated base station architecture.

FIG. 5 is a signal flow diagram including a radio unit (RU) and a distributed unit (DU).

FIG. 6 is a signal flow diagram including an RU and a DU.

FIG. 7 illustrates a block diagram including an example architecture of a DU.

FIG. 8 is a signal flow diagram including an RU, a DU and a network device in accordance with various aspects.

FIG. 9 is a flowchart of a method of wireless communication.

FIG. 10 is a flowchart of a method of wireless communication.

FIG. 11 is a conceptual data flow diagram illustrating the data flow between different means/components in an example apparatus.

FIG. 12 is a diagram illustrating an example of a hardware implementation for an apparatus employing a processing system.

FIG. 13 is a flowchart of a method of wireless communication.

FIG. 14 is a conceptual data flow diagram illustrating the data flow between different means/components in an example apparatus.

FIG. 15 is a diagram illustrating an example of a hardware implementation for an apparatus employing a processing system.

FIG. 16 is a flowchart of a method of wireless communication.

FIG. 17 is a conceptual data flow diagram illustrating the data flow between different means/components in an example apparatus.

FIG. 18 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

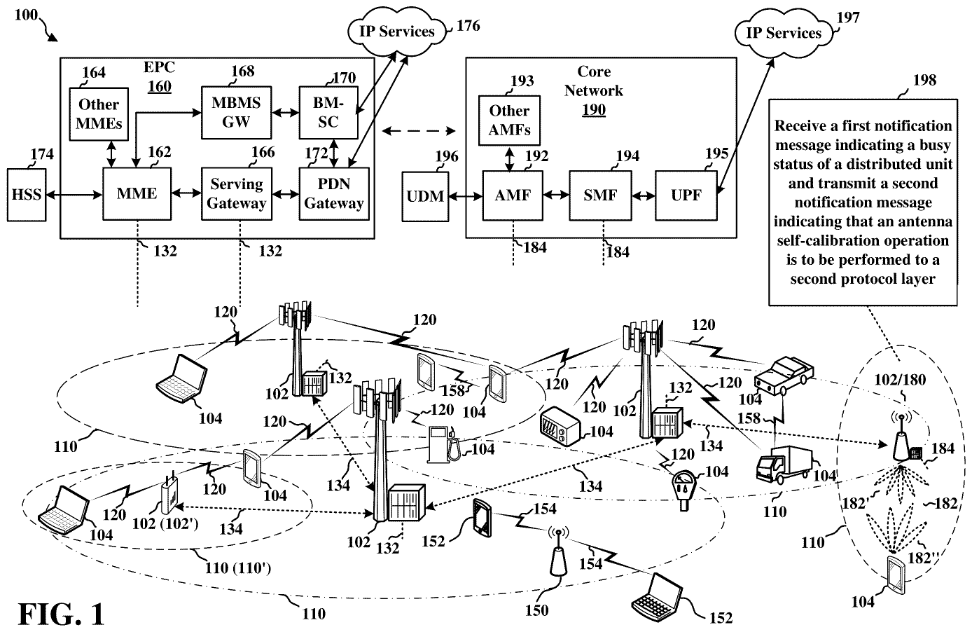

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, base station 180 (e.g., a radio unit of the base station 180) may be configured to receive a first notification message indicating a busy status of a distributed unit and transmit a second notification message indicating that an antenna self-calibration operation is to be performed to a second protocol layer (198). Although the following description may be focused on 5G NR, the concepts described herein may be applicable to other similar areas, such as LTE, LTE-A, CDMA, GSM, and other wireless technologies.

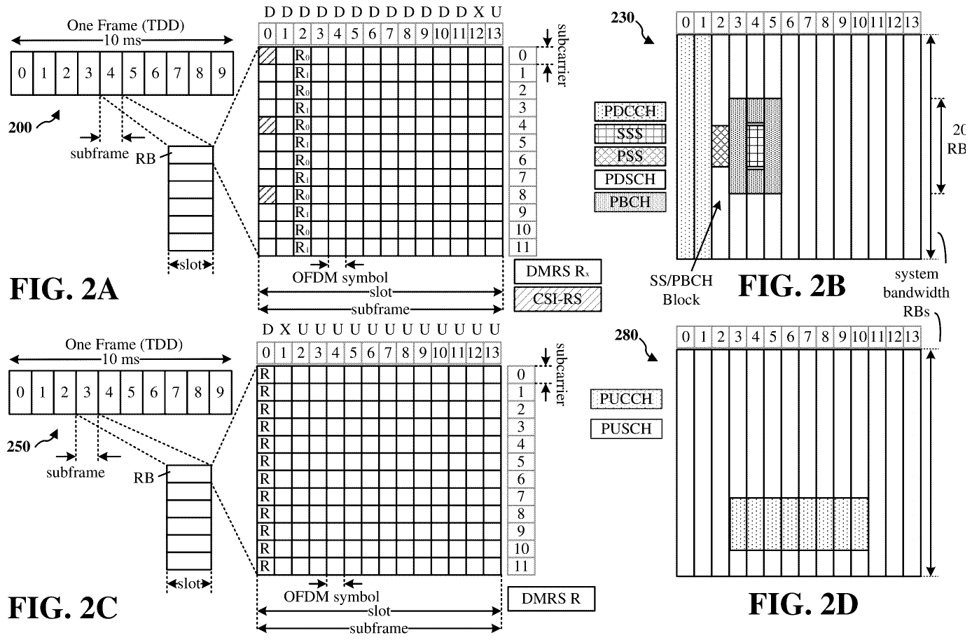

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

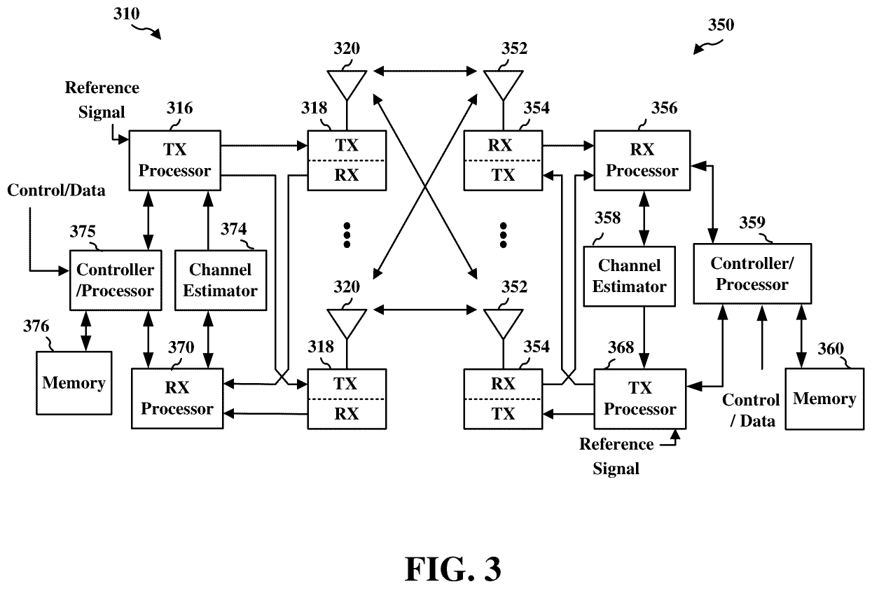

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

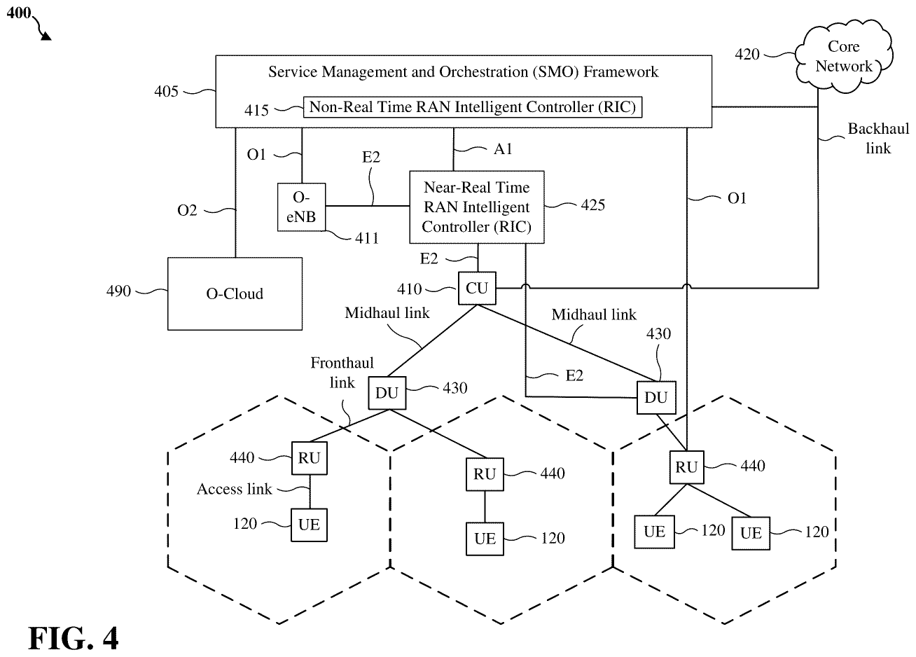

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 120 via one or more radio frequency (RF) access links. In some implementations, the UE 120 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 120. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

A radio frequency (RF) antenna (also herein referred to as an antenna) is typically calibrated to verify the performance and the measurement of the antenna's properties. In some examples, calibration of an RF antenna may be performed at an RF Front-End (RFFE) of a wireless communication device, such as at a radio unit (RU) in an O-RAN system. For example, an antenna calibration operation may involve fine tuning of RF coefficients and RF paths in the transmit (Tx), receive (Rx), and/or feedback receiver (FBRx) sides. If an antenna remains uncalibrated, the system performance of an RU and/or a DU (e.g., in an O-RAN system) may be significantly degraded.

In some examples, antenna calibration may be performed using an interface between an RU and a DU, such as a fronthaul M-Plane interface, which may allow frequency domain and time domain resource scheduling coordination between the DU and the RU for the antenna calibration. In some examples, the antenna calibration may be an online mode type of antenna calibration in an RU.

During operation of a base station (e.g., including an RU in a field deployment scenario), an antenna calibration may be performed in response to an antenna calibration trigger. The antenna calibration trigger may be a condition in which the base station (e.g., the RU of the base station) is configured to perform an antenna calibration operation.

Antenna calibration may be performed using one or more resource elements. It should be understood that resource elements (e.g., time and frequency resources) used for antenna calibration may not be used to carry traffic (e.g., data traffic), which may impact resource scheduling performed at upper protocol layers (e.g., L2). In some example scenarios, the time and frequency resources to be used for antenna calibration are negotiated between a DU and an RU before beginning the antenna calibration.

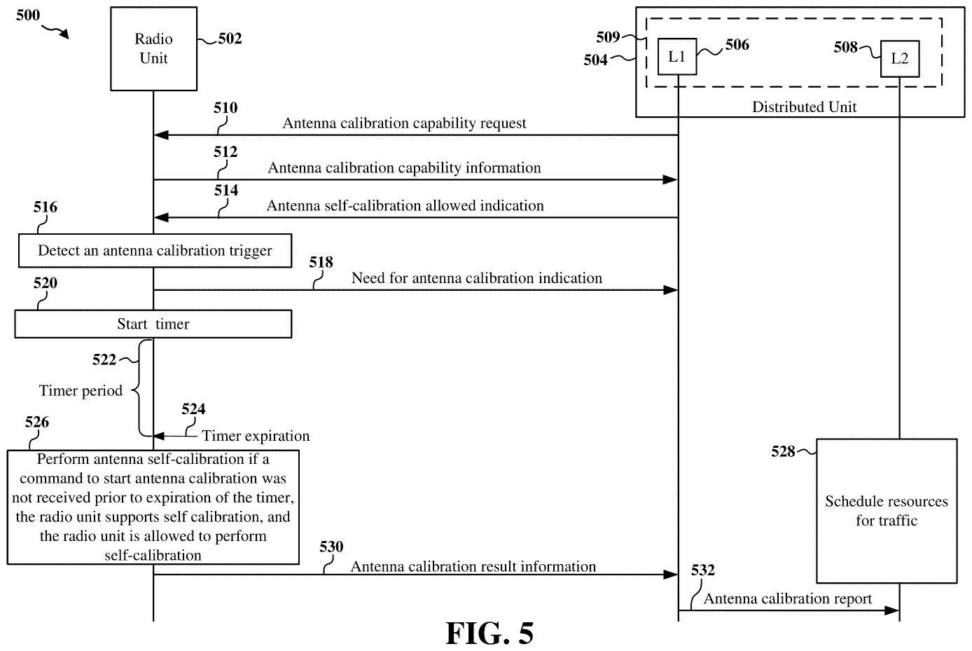

In other scenarios where the DU is unable to perform the previously mentioned negotiation of resources for antenna calibration (e.g., when the DU is busy), an RU may attempt to begin an antenna calibration without receiving an indication from the DU. In these scenarios, the RU may proceed to perform an antenna calibration operation without specific permission from the DU. This is herein referred to as a self-calibration operation. In some scenarios, a self-calibration operation at the RU may result in conflicts (e.g., resource scheduling conflicts) and a loss of data. This is described in greater detail with reference to FIG. 5.

FIG. 5 is a signal flow diagram 500 including an RU 502 (e.g., an RU in an O-RAN system) and a DU 504 (e.g., a DU in an O-RAN system). The DU 504 may implement a first protocol layer 506, such as layer 1, and a second protocol layer 508, such as layer 2. In some examples, the first protocol layer 506 and the second protocol layer 508 may be implemented at a network device 509. The second protocol layer 508 may be higher than the first protocol layer 606. In some examples, the first protocol layer may provide layer 1 (L1) functionality and the second protocol layer may provide layer 2 (L2) functionality.

As shown in FIG. 5, the DU 504 may transmit an antenna calibration capability request 510 to the RU 502. The RU 502 may transmit antenna calibration capability information 512 in response to the antenna calibration capability request 510. In some examples, the antenna calibration capability information 512 may indicate that the RU 502 supports an antenna self-calibration operation. In some examples, the antenna calibration capability information 512 may further indicate at least one of support for coordinated calibration, a number of calibration symbols per block for the DL, a number of calibration symbols per block for the UL, an interval between calibration blocks, a number of calibration blocks per step for the DL, a number of calibration blocks per step for the UL, an interval between calibration steps, a number of calibration steps, a calibration period, or a supported configured preparation timer.

In some examples, support for coordinated calibration may indicate that the RU 502 is able to determine a priori the time-frequency resources needed for self-calibration and indicate those time-frequency resources to the DU 504. In some examples, the number of calibration symbols per block for the DL indicates how many consecutive symbols are required for an antenna calibration operation in the DL. In some examples, the number of calibration symbols per block for the UL indicates how many consecutive symbols are required for an antenna calibration operation in the UL. In some examples, the interval between calibration blocks indicates a time interval (e.g., a time value expressed as a number of symbols) needed between consecutive antenna calibration operations.

In some examples, the number of calibration blocks per step for the DL indicates how many blocks are needed for one step of an antenna calibration operation in the DL. In some examples, the number of calibration blocks per step for the UL indicates how many blocks are needed for one step of an antenna calibration operation in the UL. In some examples, the interval between calibration steps indicates a time interval (e.g., a time value expressed as a number of radio frames) needed between consecutive steps of an antenna calibration operation. In some examples, the number of calibration steps indicates how many steps are needed for the entire DL and/or UL antenna calibration operation. In some examples, the calibration period indicates a periodical interval between antenna calibrations.

The DU 504 may transmit an antenna self-calibration allowed indication 514 to the RU 502. In some examples, the antenna self-calibration allowed indication 514 may be a flag set to a predetermined value (e.g., logic ‘1’) when self-calibration is allowed.

At 516, the RU 502 may detect an antenna calibration trigger. In some nonlimiting examples, the RU 502 may detect the antenna calibration trigger when a change in temperature exceeds a temperature change threshold, a change in humidity exceeds a humidity change threshold, a change in input power to the base station exceeds a power change threshold, and/or a calibration timer expires. The RU 502 may transmit a message 518 including a need for antenna calibration indication to the DU 504 in response to the detection of the antenna calibration trigger (e.g., at 516). In some examples, the message 518 including the need for antenna calibration indication may indicate one or more resources (e.g., time-frequency resources) that the RU 502 may use for an antenna calibration operation. In some examples, the one or more resources indicated in the message 518 may include resources for the UL and/or resources for the DL.

At 520, the RU may start a timer and may wait until expiration 524 of the timer period 522 before performing an antenna self-calibration operation. The timer period 522 may be preconfigured at the RU 502. In some examples, the timer period 522 may be within a range of one second to 60 seconds.

At 526, the RU 502 may perform the antenna self-calibration operation if the RU 502 supports antenna self-calibration (e.g., if the RU 502 has indicated support for antenna self-calibration in the antenna calibration capability information 512), the RU 502 is allowed to perform the antenna self-calibration operation (e.g., the RU 502 has received the antenna self-calibration allowed indication 514, such as a flag set to a predetermined value (e.g., logic ‘1’) indicating that antenna self-calibration at the RU 502 is allowed), and a command to start an antenna calibration operation was not received at the RU 502 prior to expiration 524 of the timer period 522.

It should be noted that in FIG. 5, there is no coordination of resources between the RU 502 and the DU 504 for an antenna calibration operation. For example, in some scenarios, the DU 504 may be busy, unresponsive, or a communication link between the RU 502 and the DU 504 may be temporarily degraded. In such scenarios, the DU 504 may not receive the message 518 including the need for antenna calibration indication and/or may not be available to negotiate the resources that the RU 502 is to use when performing the antenna self-calibration operation. Therefore, the RU 502 at 526 may perform an antenna self-calibration operation based on the resources indicated in the message 518 without permission from the DU 504.

While the RU 502 performs the antenna self-calibration operation at 526 based on the one or more resources (e.g., time-frequency resources) indicated in the message 518, at least one upper protocol layer (e.g., the second protocol layer 508), at 528, may schedule resources for traffic (e.g., data traffic). In some examples, the traffic may involve at least one of data for an uplink transmission or data for a downlink transmission. In some examples, the at least one upper protocol layer (e.g., the second protocol layer 508) includes at least a medium access control (MAC) layer.

If the DU 504 was unable to negotiate resources to be used for antenna calibration at the RU 502 for the reasons described herein, at least one upper protocol layer (e.g., the second protocol layer 508), at 528, may schedule (e.g., allocate) resources for traffic that conflict (e.g., at least partially overlap) with the one or more resources used at the RU 502 for the antenna self-calibration operation performed at 526. Such a conflict may cause a loss of traffic (e.g., data loss) during the antenna self-calibration operation performed at 526. Moreover, since the RU 502 may need to perform multiple antenna self-calibration operations due to changing conditions (e.g., change in temperature, humidity, input power, etc.) while in operation, the previously described resource conflicts may continue to occur and may result in a significant amount of data loss.

As previously described, in scenarios where the DU 504 is busy, unresponsive, or unable to communicate with the RU 502 (e.g., due to a temporary degradation of a communication link between the RU 502 and the DU 504), the RU 502 may need to wait until the timer period 522 expires before performing the antenna self-calibration at 526. For example, after the RU 502 transmits the message 518 including the need for antenna calibration indication to the DU 504, the RU 502 may need to wait for several seconds (e.g., up to the duration of the timer period 522) for a command to start the antenna calibration operation from the DU 504. The RF performance of the RU 502 may remain sub-optimal during this time because the RF performance of the RU 502 greatly depends on the antenna calibration operation. Since the timer period 522 may be as much as 60 seconds in some implementations, the RF performance of the RU 502 may remain sub-optimal for a significant amount of time and may negatively impact RAN performance.

The RU 502 may transmit antenna calibration result information 530 to the DU 504. The DU 504 may transmit an antenna calibration report 532 to the at least one upper protocol layer (e.g., the second protocol layer 508) implemented at the network device 509.

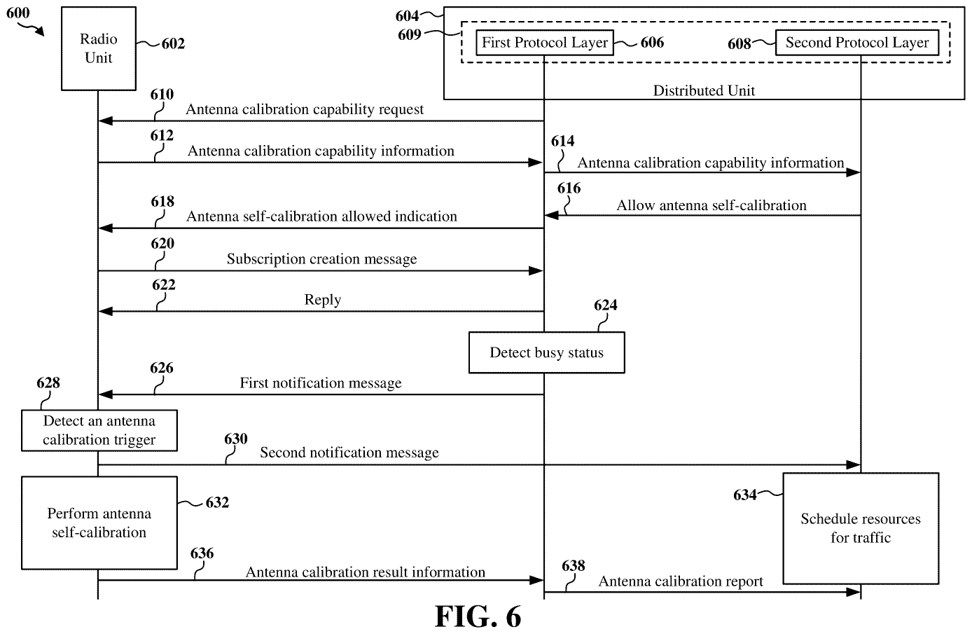

FIG. 6 is a signal flow diagram 600 including an RU 602 (e.g., an RU in an O-RAN system, such as RU 440) and a DU 604 (e.g., a DU in an O-RAN system, such as DU 430). The DU 604 may implement a first protocol layer 606 and a second protocol layer 608. In some examples, the first protocol layer 606 and the second protocol layer 608 may be implemented at a network device 609 (e.g., a server device including a processing circuit and other appropriate hardware). The second protocol layer 508 may be higher than the first protocol layer 606. In some examples, the first protocol layer may provide layer 1 (L1) functionality and the second protocol layer may provide layer 2 (L2) functionality.

As shown in FIG. 6, the DU 604 may transmit an antenna calibration capability request 610 to the RU 602. The RU 602 may transmit antenna calibration capability information 612 in response to the antenna calibration capability request 610. In some examples, the antenna calibration capability information 612 in FIG. 6 may indicate that the RU 602 supports an antenna self-calibration operation. In some examples, the antenna calibration capability information 612 may further indicate at least one of support for coordinated calibration, a number of calibration symbols per block for the DL, a number of calibration symbols per block for the UL, an interval between calibration blocks, a number of calibration blocks per step for the DL, a number of calibration blocks per step for the UL, an interval between calibration steps, a number of calibration steps, a calibration period, or a supported configured preparation timer as described herein.

The DU 604 may transmit antenna calibration capability information 614 to at least one upper protocol layer, such as the second protocol layer 608. The antenna calibration capability information 614 may include at least some of the antenna calibration capability information 612 received from the RU 602.

The second protocol layer 608 may transmit a message 616 including a configuration to allow antenna self-calibration at the RU 602 based on the antenna calibration capability information 614. The DU 604 may transmit an antenna self-calibration allowed indication 618 to the RU 602 based on the configuration to allow antenna self-calibration from the second protocol layer 608. In some examples, the antenna self-calibration allowed indication 618 may be a flag set to a predetermined value (e.g., logic ‘1’) when self-calibration is allowed.

The RU 602 may transmit a subscription creation message 620 to the DU 604 to subscribe to event notifications from the DU 604. In some aspects, the event notifications may include notifications as to the status of the DU 604. For example, the DU 604 may transmit a notification message indicating that the DU 604 is currently busy. In some nonlimiting examples, the DU 604 may transmit such notification message indicating that the DU 604 is currently busy when the DU 604 is performing one or more tasks (e.g., one or more high-priority tasks), when the DU 604 is unresponsive, and/or when a communication link between the RU 602 and the DU 604 is degraded. In some examples, a communication link between the RU 602 and the DU 604 may be degraded when a connection and/or interface between the RU 602 and the DU 604 becomes unreliable or is temporarily lost (e.g., temporarily out of sync).

The DU 604 may transmit a reply message 622 in response to the subscription creation message 620 when the RU 602 is successfully subscribed to the event notifications from the DU 604. In some examples, the subscription creation message 620 and the reply message 622 may be a remote procedure call (RPC) message exchange between the RU 602 and the DU 604 to define a subscription-notification mechanism between the RU 602 and the DU 604. In some examples, such RPC message exchange between the RU 602 and the DU 604 may be performed at the time of boot-up of the RU 602 and the DU 604.

At 624, the DU 604 may detect a busy status. In one example, the DU 604 may detect a busy status when the DU 604 is performing one or more tasks (e.g., one or more high-priority tasks). In another example, the DU 604 may detect a busy status when the DU 604 becomes unresponsive. The DU 604 may become unresponsive, for example, if layer 1 functionality provided by the first protocol layer 606 has temporarily ceased. In yet another example, the DU 604 may detect a busy status when a communication link between the RU 602 and the DU 604 is degraded (e.g., a connection and/or interface between the RU 602 and the DU 604 becomes unreliable or is temporarily lost).

The DU 604 may transmit a first notification message 626 to the RU 602 indicating the busy status of the DU 604. The first notification message 626 may represent an event notification associated with the subscription-notification mechanism created via the subscription creation message 620 and the reply message 622.

At 628, the RU 602 may detect an antenna calibration trigger. In some nonlimiting examples, the RU 602 may detect the antenna calibration trigger when a change in temperature exceeds a temperature change threshold, a change in humidity exceeds a humidity change threshold, a change in input power to the base station exceeds a power change threshold, and/or a calibration timer expires.

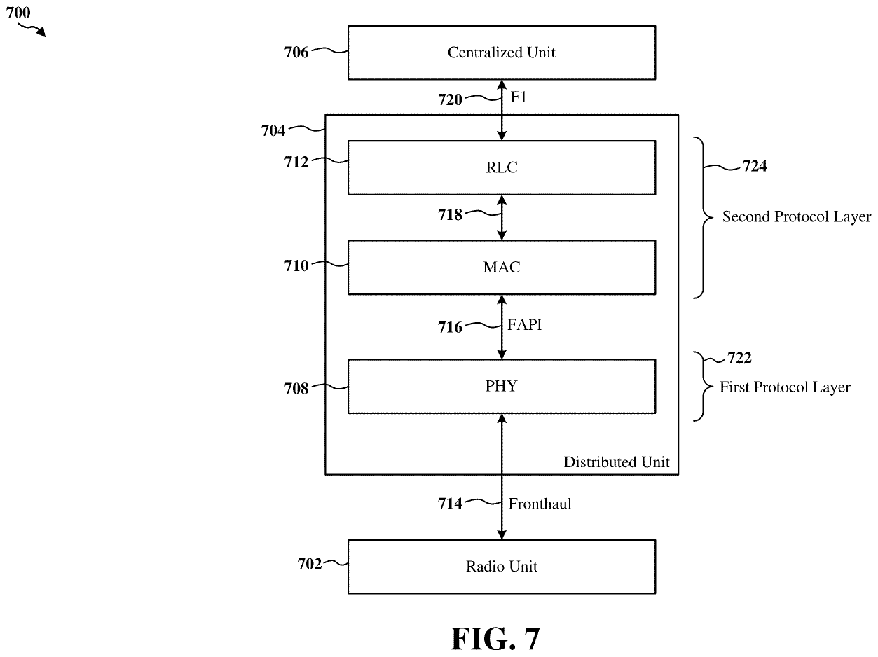

Since the RU 602 has been notified (e.g., via the first notification message 626) as to the busy status of the DU 604, the RU 602 may determine that an antenna self-calibration operation needs to be performed at the RU 602 upon detection of the antenna calibration trigger at 628. Accordingly, the RU 602 may transmit a second notification message 630 to the second protocol layer 608 implemented at the DU 604 in response to the first notification message 626 when an antenna self-calibration operation is to be performed at the RU 602. The RU 602 may transmit the second notification message 630 to the second protocol layer 608 via an application programming interface (API). In some examples, the API may be a functional application platform interface (FAPI), such as the FAPI 716 described with reference to FIG. 7.

In some examples, the second notification message 630 may indicate that an antenna self-calibration operation is to be performed at the RU 602 and may indicate one or more resources (e.g., time-frequency resources) that the RU 602 may use for the antenna self-calibration operation. In some examples, the one or more resources indicated in the second notification message 630 may include resources for the UL and/or resources for the DL. Therefore, the second notification message 630 may serve as an alarm to the second protocol layer 608 as to the antenna self-calibration operation to be performed at the RU 602. The second protocol layer 608 may include a protocol and operations, administration, and maintenance (OAM) application for processing of the second notification message 630.

At 632, the RU 602 may perform the antenna self-calibration operation. In some examples, the RU 602 may use the one or more resources indicated in the second notification message 630 for the antenna self-calibration operation.

At 634, the second protocol layer 608 implemented at the DU 604 may schedule resources (e.g., time-frequency resources) for traffic (e.g., data traffic). In some examples, the traffic may involve at least one of data for an uplink transmission or data for a downlink transmission. In some aspects of the disclosure, the second protocol layer 608 may schedule the resources (e.g., at 634) based on the one or more resources indicated in the second notification message 630. For example, the second protocol layer 608 may adjust its scheduling of resources for traffic (e.g., data traffic) by scheduling resources that do not conflict with the one or more resources indicated in the second notification message 630. Therefore, as the RU 602 performs the antenna self-calibration operation at 632, the resources scheduled at 634 may not conflict with the resources used at the RU 602 for the antenna self-calibration and data losses may be avoided.

In FIG. 6, it should be noted that the RU 602 may not be required to wait the duration of a timer period to begin performing the antenna self-calibration operation at 632 after the antenna calibration trigger is detected at 628. This is because the RU 602 is notified as to the busy status of the DU 604 via the first notification message 626, which enables the RU 602 to begin performing the antenna self-calibration operation at 632 upon detection of the antenna calibration trigger at 628 and without delays that may result from waiting for a timer (e.g., a calibration timer for controlling the start of an antenna self-calibration operation) to expire.

The RU 602 may transmit antenna calibration result information 636 to the DU 604. In some examples, the RU 602 may indicate a success or failure of an antenna calibration operation in the antenna calibration result information 636. In some examples, the RU 602 may indicate a reason for a failure of an antenna calibration operation in the antenna calibration result information 636. The DU 604 may transmit an antenna calibration report 638 (e.g., based on the antenna calibration result information 636) to the second protocol layer 608 implemented at the DU 604.

FIG. 7 illustrates a block diagram 700 including an example architecture of a DU 704. FIG. 7 includes an RU 702, the DU 704, and a CU 706. The DU 704 includes a physical (PHY) layer 708, a MAC layer 710, and an RLC layer 712. The PHY layer 708 may communicate with the MAC layer via the FAPI 716, and the MAC layer 710 may communicate with the RLC layer 712 via an interface 718. In some examples, the PHY layer 708 may be associated with a first protocol layer 722 (e.g., layer 1). In some examples, the MAC layer 710 and the RLC layer 712 may be associated with a second protocol layer 724 (e.g., layer 2).

The radio unit 702 may communicate with the DU 704 via a fronthaul link 714. The DU 704 may communicate with the CU 706 via an F1 interface 720.

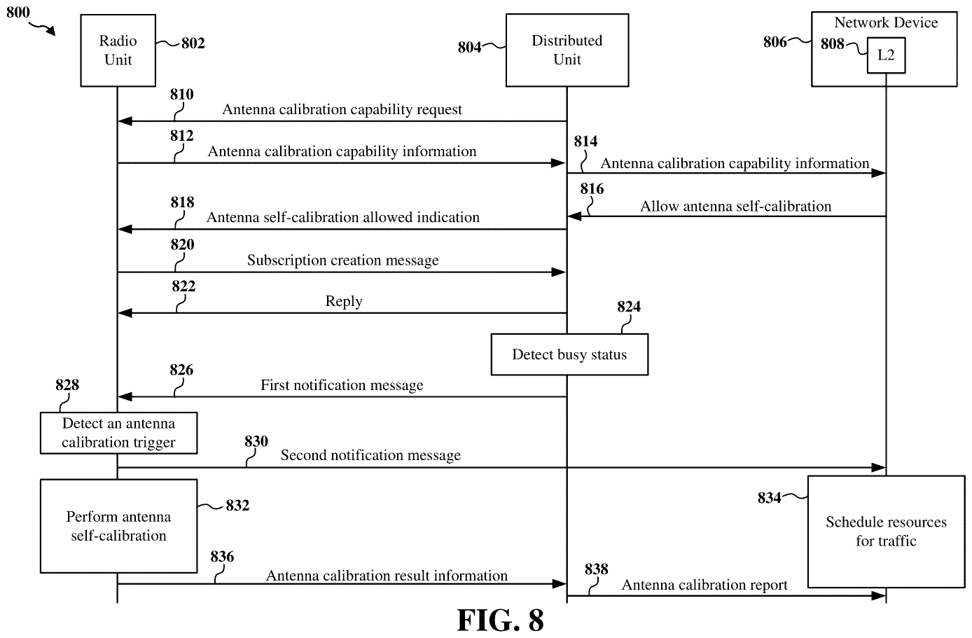

FIG. 8 is a signal flow diagram 800 including an RU 802 (e.g., an RU in an O-RAN system, such as RU 440), a DU 804 (e.g., a DU in an O-RAN system, such as DU 430) and a network device 806 in accordance with various aspects. The network device 806 may implement at least one upper protocol layer, such as layer 2 (L2) 808.

As shown in FIG. 8, the DU 804 may transmit an antenna calibration capability request 810 to the RU 802. The RU 802 may transmit antenna calibration capability information 812 in response to the antenna calibration capability request 810. In some examples, the antenna calibration capability information 812 in FIG. 8 may indicate that the RU 802 supports an antenna self-calibration operation. In some examples, the antenna calibration capability information 812 may further indicate at least one of support for coordinated calibration, a number of calibration symbols per block for the DL, a number of calibration symbols per block for the UL, an interval between calibration blocks, a number of calibration blocks per step for the DL, a number of calibration blocks per step for the UL, an interval between calibration steps, a number of calibration steps, a calibration period, or a supported configured preparation timer as described herein.

The DU 804 may transmit antenna calibration capability information 814 to at least one upper protocol layer, such as layer 2 (L2) 808 implemented at the network device 806. The antenna calibration capability information 814 may include at least some of the antenna calibration capability information 812 received from the RU 802.

The network device 806 may transmit (e.g., from layer 2 808) a message 816 including a configuration to allow antenna self-calibration at the RU 802 based on the antenna calibration capability information 814. The DU 804 may transmit an antenna self-calibration allowed indication 818 to the RU 802 based on the configuration to allow antenna self-calibration from the second protocol layer 808. In some examples, the antenna self-calibration allowed indication 818 may be a flag set to a predetermined value (e.g., logic ‘1’) when self-calibration is allowed.

The RU 802 may transmit a subscription creation message 820 to the DU 804 to subscribe to event notifications from the DU 804. In some aspects, the event notifications may include notifications as to the status of the DU 804. For example, the DU 804 may transmit a notification message indicating that the DU 804 is currently busy. In some nonlimiting examples, the DU 804 may transmit such notification message indicating that the DU 604 is currently busy when the DU 804 is performing one or more tasks (e.g., one or more high-priority tasks), when the DU 804 is unresponsive, and/or when a communication link between the RU 802 and the DU 804 is degraded. In some examples, a communication link between the RU 802 and the DU 804 may be degraded when a connection and/or interface between the RU 802 and the DU 804 becomes unreliable or is temporarily lost (e.g., temporarily out of sync).

The DU 804 may transmit a reply message 822 in response to the subscription creation message 820 when the RU 802 is successfully subscribed to the event notifications from the DU 804. In some examples, the subscription creation message 820 and the reply message 822 may be a remote procedure call (RPC) message exchange between the RU 802 and the DU 804 to define a subscription-notification mechanism between the RU 802 and the DU 804. In some examples, such RPC message exchange between the RU 802 and the DU 804 may be performed at the time of boot-up of the RU 802 and the DU 804.

At 824, the DU 804 may detect a busy status. In one example, the DU 804 may detect a busy status when the DU 804 is performing one or more tasks (e.g., one or more high-priority tasks). In another example, the DU 804 may detect a busy status when the DU 804 becomes unresponsive. The DU 804 may become unresponsive, for example, if layer 1 functionality at the distributed unit 804 has temporarily ceased. In yet another example, the DU 804 may detect a busy status when a communication link between the RU 802 and the DU 804 is degraded (e.g., a connection and/or interface between the RU 802 and the DU 804 becomes unreliable or is temporarily lost).

The DU 804 may transmit a first notification message 826 to the RU 802 indicating the busy status of the DU 804. The first notification message 826 may represent an event notification associated with the subscription-notification mechanism created via the subscription creation message 820 and the reply message 822.

At 828, the RU 802 may detect an antenna calibration trigger. In some nonlimiting examples, the RU 802 may detect the antenna calibration trigger when a change in temperature exceeds a temperature change threshold, a change in humidity exceeds a humidity change threshold, a change in input power to the base station exceeds a power change threshold, and/or a calibration timer expires.

Since the RU 802 has been notified (e.g., via the first notification message 826) as to the busy status of the DU 804, the RU 802 may determine that an antenna self-calibration operation needs to be performed at the RU 802 upon detection of the antenna calibration trigger at 828. Accordingly, the RU 802 may transmit a second notification message 830 to layer 2 808 implemented at the network device 806 in response to the first notification message 826 when an antenna self-calibration operation is to be performed at the RU 802. The RU 802 may transmit the second notification message 830 to layer 2 808 via an application programming interface (API). In some examples, the API may be a functional application platform interface (FAPI), such as the FAPI 716 described with reference to FIG. 7.

In some examples, the second notification message 830 may indicate that an antenna self-calibration operation is to be performed at the RU 802 and may indicate one or more resources (e.g., time-frequency resources) that the RU 802 may use for the antenna self-calibration operation. In some examples, the one or more resources indicated in the second notification message 830 may include resources for the UL and/or resources for the DL. Therefore, the second notification message 830 may serve as an alarm to layer 2 808 as to the antenna self-calibration operation to be performed at the RU 802. The second protocol layer 808 may include a protocol and operations, administration, and maintenance (OAM) application for processing of the second notification message 830.

At 832, the RU 802 may perform the antenna self-calibration operation. In some examples, the RU 802 may use the one or more resources indicated in the second notification message 830 for the antenna self-calibration operation.

At 834, layer 2 808 implemented at the network device 806 may schedule resources (e.g., time-frequency resources) for traffic (e.g., data traffic). In some examples, the traffic may involve at least one of data for an uplink transmission or data for a downlink transmission. In some aspects of the disclosure, layer 2 808 may schedule the resources (e.g., at 834) based on the one or more resources indicated in the second notification message 830. For example, layer 2 808 may adjust its scheduling of resources for traffic (e.g., data traffic) by scheduling resources that do not conflict with the one or more resources indicated in the second notification message 830. Therefore, as the RU 802 performs the antenna self-calibration operation at 832, the resources scheduled at 834 may not conflict with the resources used at the RU 802 for the antenna self-calibration and data losses may be avoided.

In FIG. 8, it should be noted that the RU 802 may not be required to wait the duration of a timer period to begin performing the antenna self-calibration operation at 832 after the antenna calibration trigger is detected at 828. This is because the RU 802 is notified as to the busy status of the DU 804 via the first notification message 826, which enables the RU 802 to begin performing the antenna self-calibration operation at 832 upon detection of the antenna calibration trigger at 828 and without delays that may result from waiting for a timer (e.g., a calibration timer for controlling the start of an antenna self-calibration operation) to expire.

The RU 802 may transmit antenna calibration result information 836 to the DU 804. In some examples, the RU 802 may indicate a success or failure of an antenna calibration operation in the antenna calibration result information 836. In some examples, the RU 802 may indicate a reason for a failure of an antenna calibration operation in the antenna calibration result information 836. The DU 804 may transmit an antenna calibration report 838 (e.g., based on the antenna calibration result information 836) to the second protocol layer 808 implemented at the DU 804.

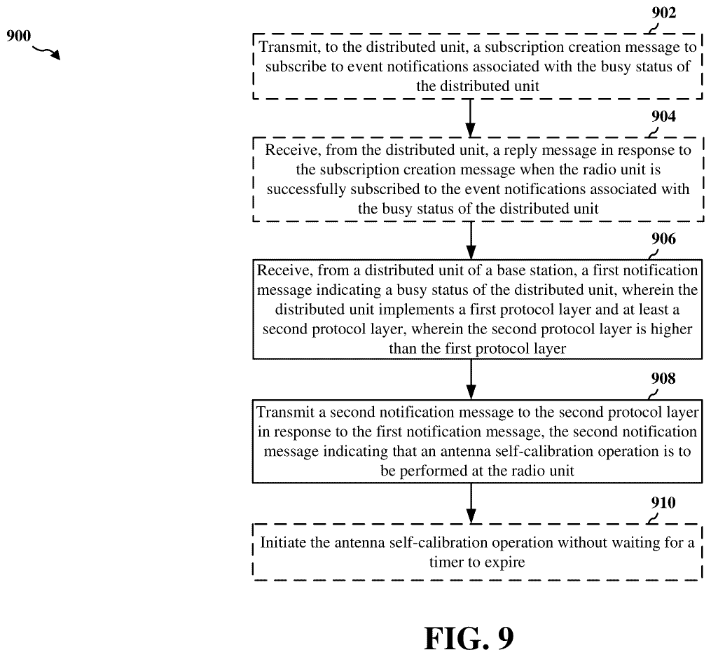

FIG. 9 is a flowchart 900 of a method of wireless communication. The method may be performed by a radio unit of a base station (e.g., the radio unit 602, 702; the apparatus 1102/1102′; the processing system 1214, which may include the memory 376 and which may be the entire radio unit 602, 702 or a component of the radio unit 602, 702, such as the TX processor 316, the RX processor 370, and/or the controller/processor 375). In FIG. 9, blocks indicated with dashed lines represent optional blocks.

At 902, the radio unit optionally transmits, to a distributed unit, a subscription creation message to subscribe to event notifications associated with the busy status of the distributed unit. The distributed unit may be an open radio access network (O-RAN) distributed unit (O-DU). For example, with reference to FIG. 6, the RU 602 may transmit the subscription creation message 620 to the DU 604 to subscribe to event notifications from the DU 604. In some aspects, the event notifications may include notifications as to the status of the DU 604, such as a notification message indicating that the DU 604 is currently busy.

At 904, the radio unit optionally receives, from the distributed unit, a reply message in response to the subscription creation message when the radio unit is successfully subscribed to the event notifications associated with the busy status of the distributed unit. For example, with reference to FIG. 6, the RU 602 may receive the reply message 622 from the DU 604 in response to the subscription creation message 620 when the RU 602 is successfully subscribed to the event notifications. In some examples, the subscription creation message 620 and the reply message 622 may be an RPC message exchange between the RU 602 and the DU 604 to define a subscription-notification mechanism between the RU 602 and the DU 604.

At 906, the radio unit receives, from a distributed unit of a base station, a first notification message indicating a busy status of the distributed unit, wherein the distributed unit implements a first protocol layer and at least a second protocol layer, wherein the second protocol layer is higher than the first protocol layer. For example, with reference to FIG. 6, the RU 602 may receive the first notification message 626 indicating the busy status of the DU 604. The first notification message 626 may represent an event notification associated with the subscription-notification mechanism created via the subscription creation message 620 and the reply message 622. In some examples, the first protocol layer may be layer 1 (e.g., PHY layer 708 in FIG. 7) and the second protocol layer may be layer 2 (e.g., the MAC layer 710 and the RLC layer 712 in FIG. 7).

At 908, the radio unit transmits a second notification message to the second protocol layer in response to the first notification message, the second notification message indicating that an antenna self-calibration operation is to be performed at the radio unit. In some aspects, the second notification message indicates one or more resources (e.g., one or more time-frequency resources) associated with the antenna self-calibration operation. The second protocol layer is configured to schedule resources for traffic (e.g., data traffic). In some aspects, the radio unit transmits the second notification message to at least the second protocol layer via an API.

For example, with reference to FIG. 6, the RU 602 may transmit the second notification message 630 to the second protocol layer 608 implemented at the DU 604 in response to the first notification message 626 when the antenna self-calibration operation is to be performed at the RU 602. The RU 602 may transmit the second notification message 630 to the second protocol layer 608 via an API. In some examples, the API may include an FAPI, such as the FAPI 716 described with reference to FIG. 7.

At 910, the radio unit optionally initiates the antenna self-calibration operation without waiting for a timer to expire. In some examples, the radio unit uses the one or more resources indicated in the second notification message 630 for the antenna self-calibration operation.

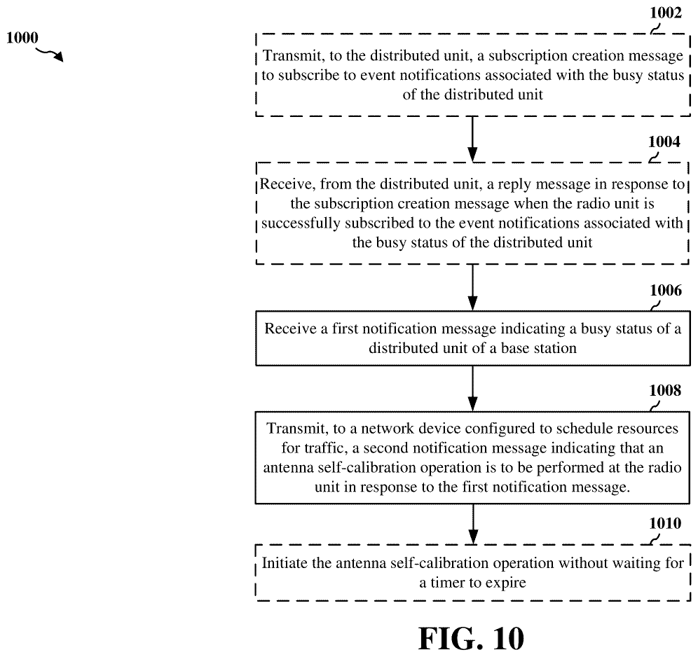

FIG. 10 is a flowchart 1000 of a method of wireless communication. The method may be performed by a radio unit of a base station (e.g., the radio unit 702, 802; the apparatus 1102/1102′; the processing system 1214, which may include the memory 376 and which may be the entire radio unit 702, 802 or a component of the radio unit 702, 802, such as the TX processor 316, the RX processor 370, and/or the controller/processor 375). In FIG. 10, blocks indicated with dashed lines represent optional blocks.

At 1002, the radio unit optionally transmits, to the distributed unit, a subscription creation message to subscribe to event notifications associated with the busy status of the distributed unit. For example, with reference to FIG. 8, the RU 802 may transmit the subscription creation message 820 to the DU 804 to subscribe to event notifications from the DU 804. In some aspects, the event notifications may include notifications as to the status of the DU 804. For example, the DU 804 may transmit a notification message indicating that the DU 804 is currently busy.

At 1004, the radio unit optionally receives, from the distributed unit, a reply message in response to the subscription creation message when the radio unit is successfully subscribed to the event notifications associated with the busy status of the distributed unit. For example, with reference to FIG. 8, the RU 802 may receive the reply message 822 from the DU 804 in response to the subscription creation message 820 when the RU 802 is successfully subscribed to the event notifications. In some examples, the subscription creation message 820 and the reply message 822 may be an RPC message exchange between the RU 802 and the DU 804 to define a subscription-notification mechanism between the RU 802 and the DU 804.

At 1006, the radio unit receives a first notification message indicating a busy status of a distributed unit of a base station. For example, with reference to FIG. 8, the RU 802 may receive the first notification message 826 from the DU 804 indicating the busy status of the DU 804. The first notification message 826 may represent an event notification associated with the subscription-notification mechanism created via the subscription creation message 820 and the reply message 822.

At 1008, the radio unit transmits, to a network device configured to schedule resources for traffic, a second notification message indicating that an antenna self-calibration operation is to be performed at the radio unit in response to the first notification message. In some aspects, the second notification message indicates one or more resources associated with the antenna self-calibration operation. In some aspects, the network device is in communication with the distributed unit. In some aspects, the RU transmits the second notification message to at least one upper protocol layer implemented at the network device via an API, wherein the at least one upper layer is configured to schedule resources for traffic.

For example, with reference to FIG. 8, the RU 802 may transmit the second notification message 830 to the layer 2 808 implemented at the network device 806 in response to the first notification message 826 when the antenna self-calibration operation is to be performed at the RU 802. The RU 802 may transmit the second notification message 830 to layer 2 808 via an API. In some examples, the API may include an FAPI, such as the FAPI 716 described with reference to FIG. 7.

At 1010, the radio unit optionally initiates the antenna self-calibration operation without waiting for a timer to expire. In some examples, with reference to FIG. 8, the RU 802 may use the one or more resources indicated in the second notification message 830 for the antenna self-calibration operation.

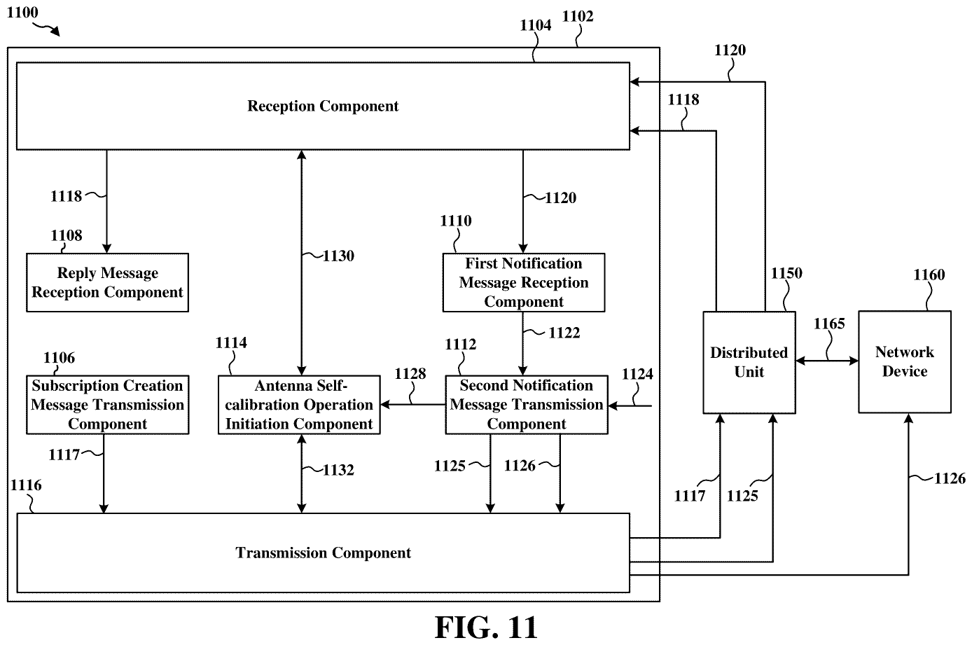

FIG. 11 is a conceptual data flow diagram 1100 illustrating the data flow between different means/components in an example apparatus 1102. The apparatus may be a radio unit of a base station.

The apparatus includes a reception component 1104 that receives messages from at least a DU 1150. The apparatus further includes a subscription creation message transmission component 1106 that transmits, to the DU 1150, a subscription creation message 1117 to subscribe to event notifications associated with the busy status of the DU 1150. The apparatus further includes reply message reception component 1108 that receives, from the DU 1150, a reply message 1118 in response to the subscription creation message 1117 when the apparatus is successfully subscribed to the event notifications associated with the busy status of the DU 1150.

The apparatus further includes a first notification message reception component 1110 that receives, from a DU 1150, a first notification message 1120 indicating a busy status of the DU 1150. The apparatus further includes a second notification message transmission component 1112 that transmits a second notification message 1125 to a second protocol layer implemented at DU 1150 in response to the first notification message 1120 (e.g., received from the first notification message reception component 1110 via the signal 1122), the second notification message 1125 indicating that an antenna self-calibration operation is to be performed at the apparatus and transmits, to the network device 1160 configured to schedule resources for traffic, a second notification message 1126 indicating that an antenna self-calibration operation is to be performed at the apparatus in response to the first notification message 1120. The second notification message transmission component 1112 may transmit the second notification message 1125, 1126 in response to an antenna calibration trigger 1124.

The apparatus further includes antenna self-calibration operation initiation component 1114 that initiates the antenna self-calibration operation without waiting for a timer to expire. The antenna self-calibration operation initiation component 1114 initiates the antenna self-calibration operation in response to a signal 1128 received from the second notification message transmission component 1112 when the second notification message 1125, 1126 is transmitted. The antenna self-calibration operation initiation component 1114 calibrates the reception component 1104 via control signals on the signal path 1130 and/or the transmission component 1116 via control signals on the signal path 1132.

The apparatus further includes a transmission component 1116 that transmits messages to the DU 1150 and the network device 1160. The DU 1150 may be in communication with the network device 1160 via the signal path 1165.

The apparatus may include additional components that perform each of the blocks of the algorithm in the aforementioned flowcharts of FIGS. 9 and 10. As such, each block in the aforementioned flowcharts of FIGS. 9 and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

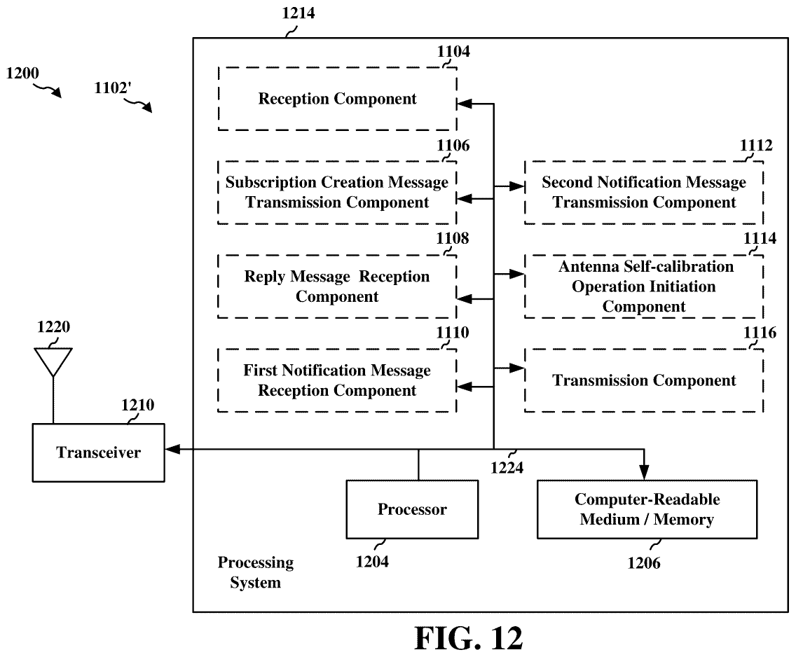

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware components, represented by the processor 1204, the components 1104, 1106, 1108, 1110, 1112, 1114, 1116 and the computer-readable medium/memory 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1104. In addition, the transceiver 1210 receives information from the processing system 1214, specifically the transmission component 1116, and based on the received information, generates a signal to be applied to the one or more antennas 1220. The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system 1214 further includes at least one of the components 1104, 1106, 1108, 1110, 1112, 1114, 1116. The components may be software components running in the processor 1204, resident/stored in the computer readable medium/memory 1206, one or more hardware components coupled to the processor 1204, or some combination thereof. The processing system 1214 may be a component of the distributed unit or may be the entire distributed unit.

In one configuration, the apparatus 1102/1102′ for wireless communication includes means for receiving, from a distributed unit of a base station, a first notification message indicating a busy status of the distributed unit, means for transmitting a second notification message to the second protocol layer in response to the first notification message, the second notification message indicating that an antenna self-calibration operation is to be performed at the apparatus, means for transmitting, to the distributed unit, a subscription creation message to subscribe to event notifications associated with the busy status of the distributed unit, means for receiving, from the distributed unit, a reply message in response to the subscription creation message when the apparatus is successfully subscribed to the event notifications associated with the busy status of the distributed unit, means for initiating the antenna self-calibration operation without waiting for a timer to expire, means for receiving a first notification message indicating a busy status of a distributed unit of a base station, and means for transmitting, to a network device configured to schedule resources for traffic, a second notification message indicating that an antenna self-calibration operation is to be performed at the apparatus in response to the first notification message. The aforementioned means may be one or more of the aforementioned components of the apparatus 1102 and/or the processing system 1214 of the apparatus 1102′ configured to perform the functions recited by the aforementioned means. As described supra, the processing system 1214 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

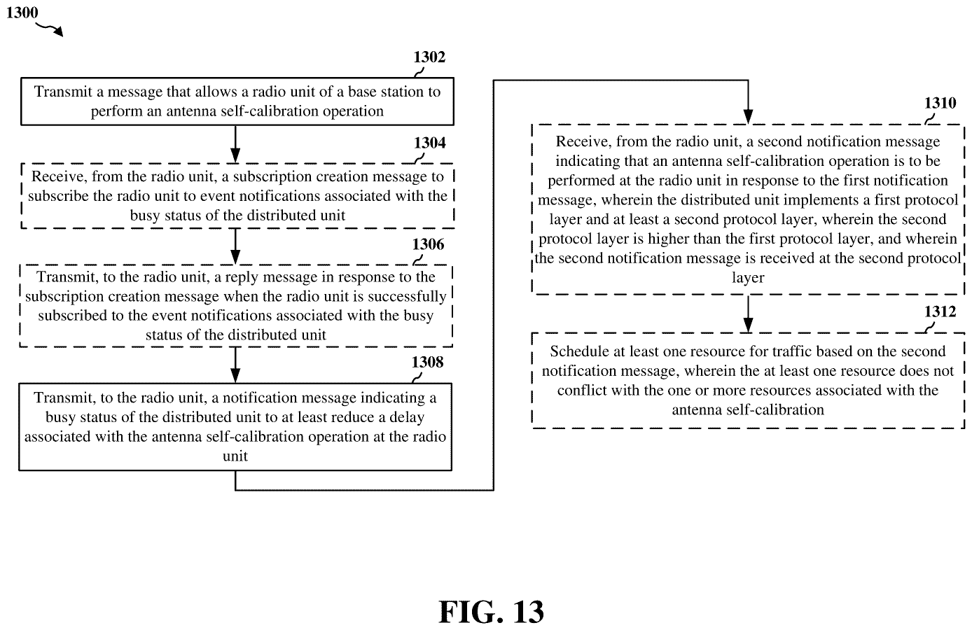

FIG. 13 is a flowchart 1300 of a method of wireless communication. The method may be performed by a distributed unit of a base station (e.g., the distributed unit 604, 704, 804; the apparatus 1402/1402′; the processing system 1514, which may be the entire distributed unit 604, 704, 804 or a component of the distributed unit 604, 704, 804. In FIG. 13, blocks indicated with dashed lines represent optional blocks.

At 1302, the distributed unit transmits a message that allows a radio unit of a base station to perform an antenna self-calibration operation. In one example, with reference to FIG. 6, the DU 604 may transmit the antenna self-calibration allowed indication 618 to the RU 602 based on the configuration to allow antenna self-calibration from the second protocol layer 608. In some examples, the antenna self-calibration allowed indication 618 may be a flag set to a predetermined value (e.g., logic ‘1’) when self-calibration is allowed. In another example, with reference to FIG. 8, the DU 804 may transmit the antenna self-calibration allowed indication 818 to the RU 802 based on the configuration to allow antenna self-calibration from the second protocol layer 808. In some examples, the antenna self-calibration allowed indication 818 may be a flag set to a predetermined value (e.g., logic ‘1’) when self-calibration is allowed.

At 1304, the distributed unit optionally receives, from the radio unit, a subscription creation message to subscribe the radio unit to event notifications associated with the busy status of the distributed unit. In one example, with reference to FIG. 6, the DU 604 may receive the subscription creation message 620 from the RU 602. In another example, with reference to FIG. 8, the DU 804 may receive the subscription creation message 820 from the RU 802.

At 1306, the distributed unit optionally transmits, to the radio unit, a reply message in response to the subscription creation message when the radio unit is successfully subscribed to the event notifications associated with the busy status of the distributed unit. In one example, with reference to FIG. 6, the DU 604 may transmit the reply message 622 in response to the subscription creation message 620 when the RU 602 is successfully subscribed to the event notifications. In another example, with reference to FIG. 8, the DU 804 may transmit the reply message 822 in response to the subscription creation message 820 when the RU 802 is successfully subscribed to the event notifications.

At 1308, the distributed unit transmits, to the radio unit, a notification message indicating a busy status of the distributed unit to at least reduce a delay associated with the antenna self-calibration operation at the radio unit. In one example, with reference to FIG. 6, the DU 604 may transmit the first notification message 626 to the RU 602 indicating the busy status of the DU 604. The first notification message 626 may represent an event notification associated with the subscription-notification mechanism created via the subscription creation message 620 and the reply message 622. In another example, with reference to FIG. 8, the DU 804 may transmit the first notification message 826 to the RU 802 indicating the busy status of the DU 804.

At 1310, the distributed unit optionally receives, from the radio unit, a second notification message indicating that an antenna self-calibration operation is to be performed at the radio unit in response to the first notification message, wherein the distributed unit implements a first protocol layer and at least a second protocol layer, wherein the second protocol layer is higher than the first protocol layer, and wherein the second notification message is received at the second protocol layer.

For example, with reference to FIG. 6, the DU 604 may receive the second notification message 630 at the second protocol layer 608 implemented at the DU 604 in response to the first notification message 626 when the antenna self-calibration operation is to be performed at the RU 602. The DU 604 may receive the second notification message 630 at the second protocol layer 608 via an API. In some examples, the API may be an FAPI, such as the FAPI 716 described with reference to FIG. 7.

At 1312, the distributed unit optionally schedules at least one resource for traffic based on the second notification message, wherein the at least one resource does not conflict with the one or more resources associated with the antenna self-calibration. For example, with reference to FIG. 6, the DU 604 (e.g., at the second protocol layer 608) may schedule resources (e.g., time-frequency resources) for traffic (e.g., data traffic). In some examples, the traffic may involve at least one of data for an uplink transmission or data for a downlink transmission. In some aspects of the disclosure, the second protocol layer 608 may schedule the resources (e.g., at 634) based on the one or more resources indicated in the second notification message 630. For example, the second protocol layer 608 may adjust its scheduling of resources for traffic (e.g., data traffic) by scheduling resources that do not conflict with the one or more resources indicated in the second notification message 630.

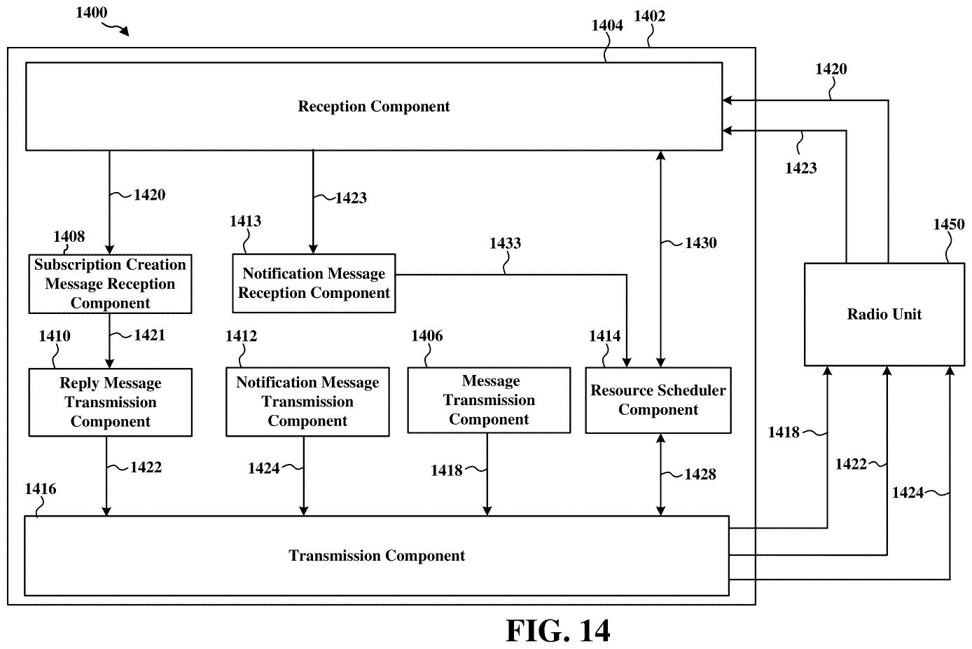

FIG. 14 is a conceptual data flow diagram 1400 illustrating the data flow between different means/components in an example apparatus 1402. The apparatus may be a distributed unit of a base station.

The apparatus includes a reception component 1404 that receives messages from at least an RU 1450. The apparatus includes a message transmission component 1406 that transmits a message 1418 that allows a radio unit of a base station to perform an antenna self-calibration operation. The apparatus includes a subscription creation message reception component 1408 that receives, from the RU 1450, a subscription creation message component 1408 to subscribe the RU 1450 to event notifications associated with the busy status of the apparatus. The apparatus includes a reply message transmission component 1410 that transmits, to the RU 1450, a reply message 1422 in response to the subscription creation message 1420 (e.g., received from the subscription creation message reception component 1408 via a signal 1421) when the RU 1450 is successfully subscribed to the event notifications associated with the busy status of the apparatus.

The apparatus includes a notification message transmission component 1412 that transmits, to the RU 1450, a notification message indicating a busy status of the apparatus to at least reduce a delay associated with the antenna self-calibration operation at the RU 1450. The apparatus includes a notification message reception component 1413 that receives, from the RU 1450, a second notification message 1423 indicating that an antenna self-calibration operation is to be performed at the apparatus in response to the first notification message, wherein the apparatus implements a first protocol layer and at least a second protocol layer, wherein the second protocol layer is higher than the first protocol layer, and wherein the second notification message is received at the second protocol layer.

The apparatus includes a resource scheduler component 1414 that schedules (e.g., via signal path 1428, 1430) at least one resource for traffic based on the second notification message (e.g., the second notification message 1423 received via signal 1433), wherein the at least one resource does not conflict with the one or more resources associated with the antenna self-calibration. The second notification message 1423 indicates one or more resources associated with the antenna self-calibration operation. The apparatus includes a transmission component 1416 that transmits messages to at least the RU 1450.

The apparatus may include additional components that perform each of the blocks of the algorithm in the aforementioned flowchart of FIG. 13. As such, each block in the aforementioned flowchart of FIG. 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

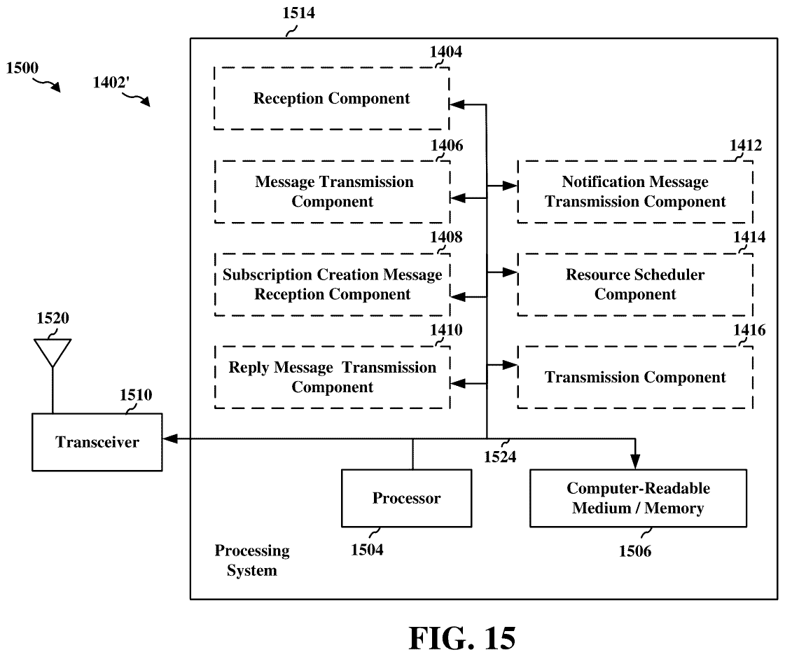

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware components, represented by the processor 1504, the components 1404, 1406, 1408, 1410, 1412, 1414, 1416 and the computer-readable medium/memory 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception component 1404. In addition, the transceiver 1510 receives information from the processing system 1514, specifically the transmission component 1416, and based on the received information, generates a signal to be applied to the one or more antennas 1520. The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system 1514 further includes at least one of the components 1404, 1406, 1408, 1410, 1412, 1414, 1416. The components may be software components running in the processor 1504, resident/stored in the computer readable medium/memory 1506, one or more hardware components coupled to the processor 1504, or some combination thereof.

In one configuration, the apparatus 1402/1402′ for wireless communication includes means for transmitting a message that allows a radio unit of a base station to perform an antenna self-calibration operation, means for transmitting, to the radio unit, a notification message indicating a busy status of the apparatus to at least reduce a delay associated with the antenna self-calibration operation at the radio unit, means for receiving, from the radio unit, a subscription creation message to subscribe the radio unit to event notifications associated with the busy status of the apparatus, means for transmitting, to the radio unit, a reply message in response to the subscription creation message when the radio unit is successfully subscribed to the event notifications associated with the busy status of the apparatus, means for receiving, from the radio unit, a second notification message indicating that an antenna self-calibration operation is to be performed at the apparatus in response to the first notification message, wherein the apparatus implements a first protocol layer and at least a second protocol layer, wherein the second protocol layer is higher than the first protocol layer, and wherein the second notification message is received at the second protocol layer, and means for scheduling at least one resource for traffic based on the second notification message, wherein the at least one resource does not conflict with the one or more resources associated with the antenna self-calibration. The aforementioned means may be one or more of the aforementioned components of the apparatus 1402 and/or the processing system 1514 of the apparatus 1402′ configured to perform the functions recited by the aforementioned means.

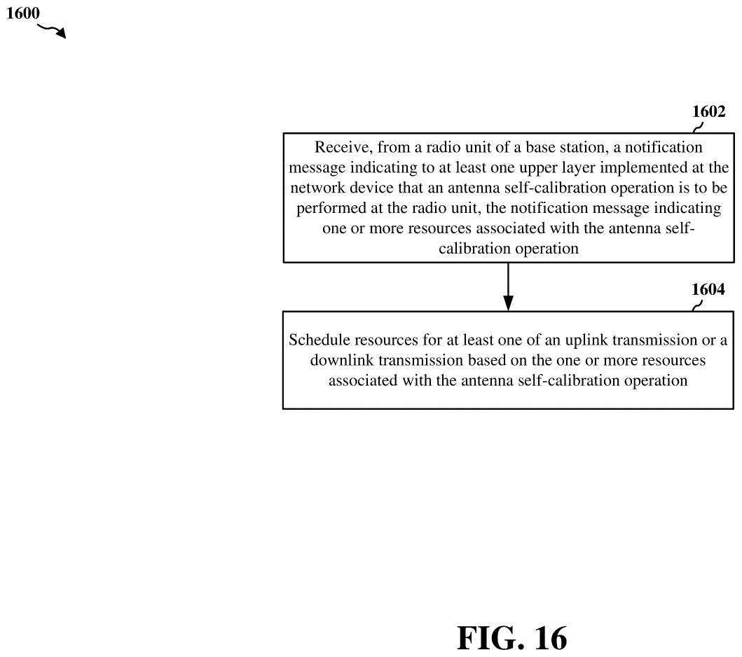

FIG. 16 is a flowchart 1600 of a method of wireless communication. The method may be performed by a network device (e.g., the network device 806; the apparatus 1702/1702′; the processing system 1814, which may be the entire network device 806 or a component of the network device 806).

At 1602, the network device receives, from a radio unit of a base station, a notification message indicating to at least one upper layer implemented at the network device that an antenna self-calibration operation is to be performed at the radio unit, the notification message indicating one or more resources associated with the antenna self-calibration operation. In some aspects, the at least one upper layer includes at least a MAC layer. For example, with reference to FIG. 8, the network device 806 may receive the second notification message 830 at layer 2 808 implemented at the network device 806.

At 1604, the network device schedules resources for at least one of an uplink transmission or a downlink transmission based on the one or more resources associated with the antenna self-calibration operation. In some examples, the scheduled resources do not conflict with the one or more resources associated with the antenna self-calibration. For example, with reference to FIG. 8, the network device 806 (e.g., at layer 2 808 implemented at the network device 806) may schedule resources (e.g., time-frequency resources) for traffic (e.g., data traffic). In some examples, the traffic may involve at least one of data for an uplink transmission or data for a downlink transmission. In some aspects of the disclosure, the network device 806 (e.g., at layer 2 808 implemented at the network device 806) may schedule the resources (e.g., at 834) based on the one or more resources indicated in the second notification message 830. For example, the network device 806 (e.g., at layer 2 808 implemented at the network device 806) may adjust its scheduling of resources for traffic (e.g., data traffic) by scheduling resources that do not conflict with the one or more resources indicated in the second notification message 830.

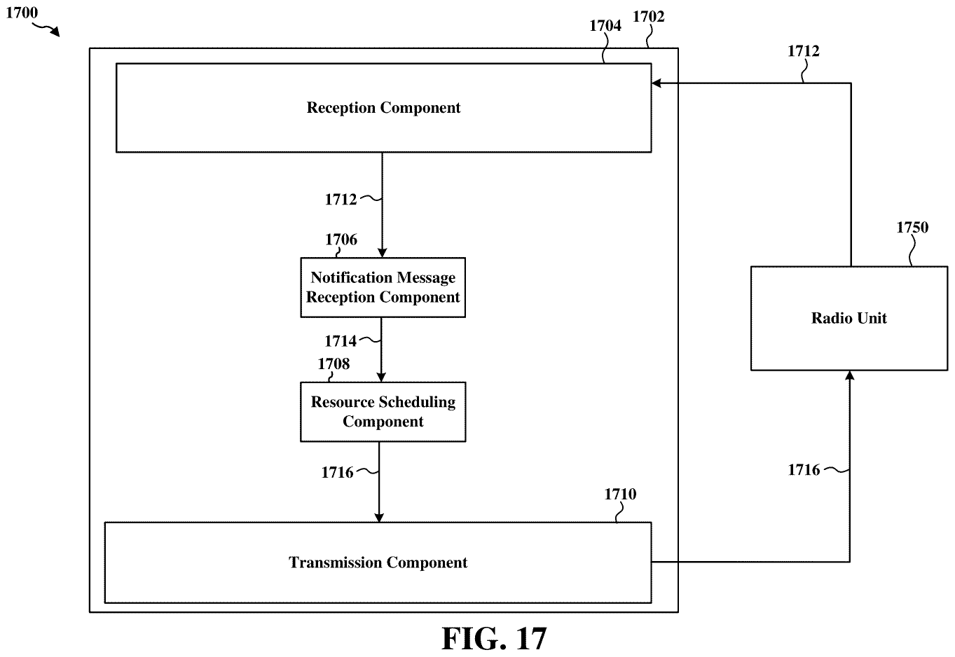

FIG. 17 is a conceptual data flow diagram 1700 illustrating the data flow between different means/components in an example apparatus 1702. The apparatus may be a network device (e.g., the network device 806).

The apparatus includes a reception component 1704 that receives messages from at least the RU 1750.

The apparatus includes a notification message reception component 1706 that receives, from the RU 1750, a notification message 1712 indicating to at least one upper layer implemented at the apparatus that an antenna self-calibration operation is to be performed at the radio unit, the notification message indicating one or more resources associated with the antenna self-calibration operation.

The apparatus includes a resource scheduling component 1708 that schedules resources for at least one of an uplink transmission or a downlink transmission based on the one or more resources associated with the antenna self-calibration operation. The resource scheduling component 1708 receives a signal 1714 indicating the one or more resources associated with the antenna self-calibration operation as indicated in the notification message 1712.

The apparatus includes a transmission component 1710 that transmits messages to at least the RU 1750.

The apparatus may include additional components that perform each of the blocks of the algorithm in the aforementioned flowchart of FIG. 16. As such, each block in the aforementioned flowchart of FIG. 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

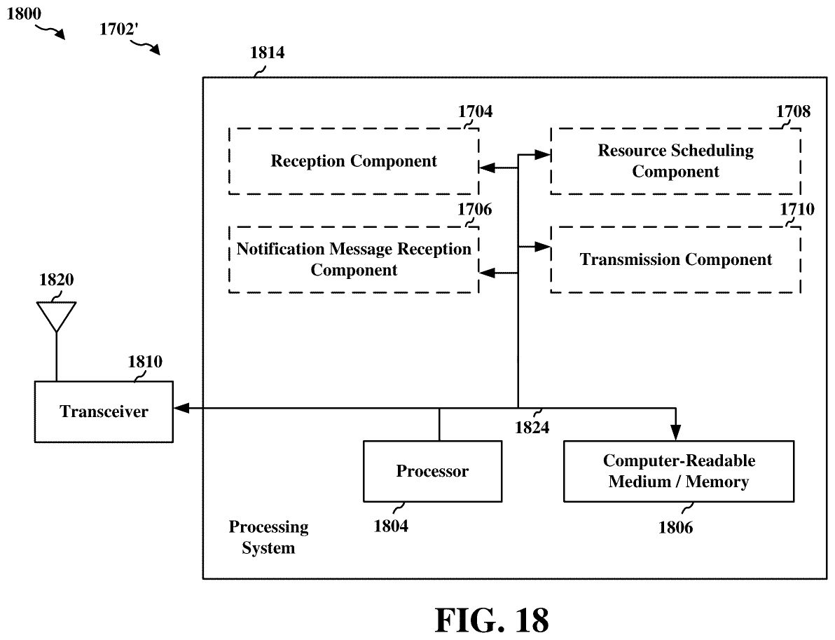

FIG. 18 is a diagram 1800 illustrating an example of a hardware implementation for an apparatus 1702′ employing a processing system 1814. The processing system 1814 may be implemented with a bus architecture, represented generally by the bus 1824. The bus 1824 may include any number of interconnecting buses and bridges depending on the specific application of the processing system 1814 and the overall design constraints. The bus 1824 links together various circuits including one or more processors and/or hardware components, represented by the processor 1804, the components 1704, 1706, 1708, 1710, and the computer-readable medium/memory 1806. The bus 1824 may also link various other circuits such as timing sources, peripherals, voltage regulators, and power management circuits, which are well known in the art, and therefore, will not be described any further.

The processing system 1814 may be coupled to a transceiver 1810. The transceiver 1810 is coupled to one or more antennas 1820. The transceiver 1810 provides a means for communicating with various other apparatus over a transmission medium. The transceiver 1810 receives a signal from the one or more antennas 1820, extracts information from the received signal, and provides the extracted information to the processing system 1814, specifically the reception component 1704. In addition, the transceiver 1810 receives information from the processing system 1814, specifically the transmission component 1710, and based on the received information, generates a signal to be applied to the one or more antennas 1820. The processing system 1814 includes a processor 1804 coupled to a computer-readable medium/memory 1806. The processor 1804 is responsible for general processing, including the execution of software stored on the computer-readable medium/memory 1806. The software, when executed by the processor 1804, causes the processing system 1814 to perform the various functions described supra for any particular apparatus. The computer-readable medium/memory 1806 may also be used for storing data that is manipulated by the processor 1804 when executing software. The processing system 1814 further includes at least one of the components 1704, 1706, 1708, 1710. The components may be software components running in the processor 1804, resident/stored in the computer readable medium/memory 1806, one or more hardware components coupled to the processor 1804, or some combination thereof.

In one configuration, the apparatus 1702/1702′ for wireless communication includes means for receiving, from a radio unit of a base station, a notification message indicating to at least one upper layer implemented at the apparatus that an antenna self-calibration operation is to be performed at the radio unit, the notification message indicating one or more resources associated with the antenna self-calibration operation, and means for scheduling resources for at least one of an uplink transmission or a downlink transmission based on the one or more resources associated with the antenna self-calibration operation. The aforementioned means may be one or more of the aforementioned components of the apparatus 1702 and/or the processing system 1814 of the apparatus 1702′ configured to perform the functions recited by the aforementioned means.

Therefore, the aspects described herein allow an RU (e.g., RU 602, 802) to transmit a notification message to at least one upper protocol layer (e.g., layer 2) implemented at a DU or a network device to indicate that an antenna self-calibration operation is to be performed at the RU. Since the notification message may indicate resources (e.g., time-frequency resources) the RU will use for the antenna self-calibration operation, scheduling operations handled at the at least one upper protocol layer may not schedule data traffic on the indicated resources. This may avoid scheduling conflicts and data loss, resulting in improved operation and an improved user experience. Moreover, the notification message may enable the RU to initiate the antenna self-calibration operation without waiting for a timer to expire, which may reduce delays in starting the antenna self-calibration operation at the RU. This may enable the RU to perform the antenna self-calibration operation sooner to improve the performance of the RU.

The following provides an overview of aspects of the present disclosure:
Aspect 1: An apparatus for wireless communication, comprising: a memory; and at least one processor coupled to the memory and configured to: receive, from a distributed unit of a base station, a first notification message indicating a busy status of the distributed unit, wherein the distributed unit implements a first protocol layer and at least a second protocol layer, wherein the second protocol layer is higher than the first protocol layer; and transmit a second notification message to the second protocol layer in response to the first notification message, the second notification message indicating that an antenna self-calibration operation is to be performed at the apparatus.
Aspect 2: The apparatus of aspect 1, wherein the at least one processor is further configured to: transmit, to the distributed unit, a subscription creation message to subscribe to event notifications associated with the busy status of the distributed unit; and receive, from the distributed unit, a reply message in response to the subscription creation message when the apparatus is successfully subscribed to the event notifications associated with the busy status of the distributed unit.
Aspect 3: The apparatus of aspect 1 or 2, wherein the at least one processor is further configured to: initiate the antenna self-calibration operation without waiting for a timer to expire.
Aspect 4: The apparatus of any of aspects 1 through 3, wherein the second notification message indicates one or more resources associated with the antenna self-calibration operation.
Aspect 5: The apparatus of any of aspects 1 through 4, wherein the second protocol layer is configured to schedule resources for traffic.
Aspect 6: The apparatus of any of aspects 1 through 5, wherein the second notification message is transmitted to at least the second protocol layer via an application programming interface (API).
Aspect 7: The apparatus of any of aspects 1 through 6, wherein the distributed unit is an open radio access network (O-RAN) distributed unit (O-DU).
Aspect 8: An apparatus for wireless communication, comprising: a memory; and at least one processor coupled to the memory and configured to: receive a first notification message indicating a busy status of a distributed unit of a base station; and transmit, to a network device configured to schedule resources for traffic, a second notification message indicating that an antenna self-calibration operation is to be performed at the apparatus in response to the first notification message.
Aspect 9: The apparatus of aspect 8, wherein the at least one processor is further configured to: transmit, to the distributed unit, a subscription creation message to subscribe to event notifications associated with the busy status of the distributed unit; and receive, from the distributed unit, a reply message in response to the subscription creation message when the apparatus is successfully subscribed to the event notifications associated with the busy status of the distributed unit.
Aspect 10: The apparatus of aspect 8 or 9, wherein the at least one processor is further configured to: initiate the antenna self-calibration operation without waiting for a timer to expire.
Aspect 11: The apparatus of any of aspects 8 through 10, wherein the second notification message indicates one or more resources associated with the antenna self-calibration operation.
Aspect 12: The apparatus of any of aspects 8 through 11, wherein the network device is in communication with the distributed unit.
Aspect 13: The apparatus of any of aspects 8 through 12, wherein the second notification message is transmitted to at least one upper protocol layer implemented at the network device via an application programming interface (API), wherein the at least one upper layer is configured to schedule resources for traffic.
Aspect 14: The apparatus of any of aspects 8 through 13, wherein the distributed unit is an open radio access network (O-RAN) distributed unit (O-DU).
Aspect 15: The apparatus of any of aspects 8 through 14, wherein the distributed unit includes the network device.
Aspect 16: An apparatus for wireless communication, comprising: a memory; and at least one processor coupled to the memory and configured to: transmit a message that allows a radio unit of a base station to perform an antenna self-calibration operation; and transmit, to the radio unit, a notification message indicating a busy status of the apparatus to at least reduce a delay associated with the antenna self-calibration operation at the radio unit.
Aspect 17: The apparatus of aspect 16, wherein the at least one processor is further configured to: receive, from the radio unit, a subscription creation message to subscribe the radio unit to event notifications associated with the busy status of the apparatus; and transmit, to the radio unit, a reply message in response to the subscription creation message when the radio unit is successfully subscribed to the event notifications associated with the busy status of the apparatus.
Aspect 18: The apparatus of aspect 16 or 17, wherein the at least one processor is further configured to: receive, from the radio unit, a second notification message indicating that an antenna self-calibration operation is to be performed at the apparatus in response to the first notification message, wherein the apparatus implements a first protocol layer and at least a second protocol layer, wherein the second protocol layer is higher than the first protocol layer, and wherein the second notification message is received at the second protocol layer.
Aspect 19: The apparatus of any of aspects 16 through 18, wherein the notification message indicates one or more resources associated with the antenna self-calibration operation, wherein the at least one processor is further configured to: schedule at least one resource for traffic based on the second notification message, wherein the at least one resource does not conflict with the one or more resources associated with the antenna self-calibration.
Aspect 20: The apparatus of any of aspects 16 through 19, wherein the radio unit is an open radio access network (O-RAN) radio unit (O-RU).
Aspect 21: An apparatus for wireless communication, comprising: a memory; and at least one processor coupled to the memory and configured to: receive, from a radio unit of a base station, a notification message indicating to at least one upper layer implemented at the apparatus that an antenna self-calibration operation is to be performed at the radio unit, the notification message indicating one or more resources associated with the antenna self-calibration operation; and schedule resources for at least one of an uplink transmission or a downlink transmission based on the one or more resources associated with the antenna self-calibration operation.
Aspect 22: The apparatus of aspect 21, wherein the scheduled resources do not conflict with the one or more resources associated with the antenna self-calibration.
Aspect 23: The apparatus of aspect 21 or 22, wherein the at least one upper layer includes at least a medium access control (MAC) layer.
Aspect 24: The apparatus of any of aspects 21 through 23, wherein the radio unit is an open radio access network (O-RAN) radio unit (O-RU).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. An apparatus for wireless communication, comprising:
a memory; and
at least one processor coupled to the memory and configured to:
receive, from a distributed unit of a base station, a first notification message indicating a busy status of the distributed unit, wherein the distributed unit implements a first protocol layer and at least a second protocol layer, wherein the second protocol layer is higher than the first protocol layer; and
transmit a second notification message to the second protocol layer in response to the first notification message, the second notification message indicating that an antenna self-calibration operation is to be performed at the apparatus.

2. The apparatus of claim 1, wherein the at least one processor is further configured to:
transmit, to the distributed unit, a subscription creation message to subscribe to event notifications associated with the busy status of the distributed unit; and
receive, from the distributed unit, a reply message in response to the subscription creation message when the apparatus is successfully subscribed to the event notifications associated with the busy status of the distributed unit.

3. The apparatus of claim 1, wherein the at least one processor is further configured to:
initiate the antenna self-calibration operation without waiting for a timer to expire.

4. The apparatus of claim 1, wherein the second notification message indicates one or more resources associated with the antenna self-calibration operation.

5. The apparatus of claim 1, wherein the second protocol layer is configured to schedule resources for traffic.

6. The apparatus of claim 1, wherein the second notification message is transmitted to at least the second protocol layer via an application programming interface (API).

7. The apparatus of claim 1, wherein the distributed unit is an open radio access network (O-RAN) distributed unit (O-DU).

8. An apparatus for wireless communication, comprising:
a memory; and
at least one processor coupled to the memory and configured to:
receive a first notification message indicating a busy status of a distributed unit of a base station; and
transmit, to a network device configured to schedule resources for traffic, a second notification message indicating that an antenna self-calibration operation is to be performed at the apparatus in response to the first notification message.

9. The apparatus of claim 8, wherein the at least one processor is further configured to:
transmit, to the distributed unit, a subscription creation message to subscribe to event notifications associated with the busy status of the distributed unit; and
receive, from the distributed unit, a reply message in response to the subscription creation message when the apparatus is successfully subscribed to the event notifications associated with the busy status of the distributed unit.

10. The apparatus of claim 8, wherein the at least one processor is further configured to:
initiate the antenna self-calibration operation without waiting for a timer to expire.

11. The apparatus of claim 8, wherein the second notification message indicates one or more resources associated with the antenna self-calibration operation.

12. The apparatus of claim 8, wherein the network device is in communication with the distributed unit.

13. The apparatus of claim 8, wherein the second notification message is transmitted to at least one upper protocol layer implemented at the network device via an application programming interface (API), wherein the at least one upper layer is configured to schedule resources for traffic.

14. The apparatus of claim 8, wherein the distributed unit is an open radio access network (O-RAN) distributed unit (O-DU).

15. The apparatus of claim 8, wherein the distributed unit includes the network device.

16. An apparatus for wireless communication, comprising:
a memory; and
at least one processor coupled to the memory and configured to:
transmit a message that allows a radio unit of a base station to perform an antenna self-calibration operation; and
transmit, to the radio unit, a notification message indicating a busy status of the apparatus to at least reduce a delay associated with the antenna self-calibration operation at the radio unit.

17. The apparatus of claim 16, wherein the at least one processor is further configured to:
receive, from the radio unit, a subscription creation message to subscribe the radio unit to event notifications associated with the busy status of the apparatus; and
transmit, to the radio unit, a reply message in response to the subscription creation message when the radio unit is successfully subscribed to the event notifications associated with the busy status of the apparatus.

18. The apparatus of claim 16, wherein the at least one processor is further configured to:
receive, from the radio unit, a second notification message indicating that an antenna self-calibration operation is to be performed at the apparatus in response to the first notification message, wherein the apparatus implements a first protocol layer and at least a second protocol layer, wherein the second protocol layer is higher than the first protocol layer, and wherein the second notification message is received at the second protocol layer.

19. The apparatus of claim 18, wherein the notification message indicates one or more resources associated with the antenna self-calibration operation, wherein the at least one processor is further configured to:
schedule at least one resource for traffic based on the second notification message, wherein the at least one resource does not conflict with the one or more resources associated with the antenna self-calibration.

20. The apparatus of claim 16, wherein the radio unit is an open radio access network (O-RAN) radio unit (O-RU).

21-24. (canceled)
